(19) United States
(12) Patent Application Publication
(10) Pub. No.: US 2009/0234860 A1
(43) Pub. Date: Sep. 17, 2009

(54) Service-Oriented Architecture System and Method

(75) Inventor: Bradley D. Brown, Littleton, CO (US)

Correspondence Address: LANIER FORD SHAVER & PAYNE P.C., P O BOX 2087, HUNTSVILLE, AL, 35804-2087, US

(73) Assignee: Rolta International, Inc., Alpharetta, GA (US)

(21) Appl. No.: 12/349,821

(22) Filed: Jan. 7, 2009

Related U.S. Application Data
(60) Provisional application No. 61/036,364, filed on Mar. 13, 2008.

(51) Int. Cl. G06F 17/30

(52) U.S. Cl. 707/10; 707/E17.001

(57) ABSTRACT

A system of the present disclosure has a first computing device storing an external data source in memory. Further, the system has logic that retrieves data indicative of services and/or objects related to the external data source and generates data identifying the location of the services and/or objects and how the services and/or objects behave. The logic further generates logic for connecting to the services and/or objects.

### REFERENCE TO RELATED APPLICATION

This application claims priority to U.S. provisional patent application Ser. No. 61/036,364, entitled “Universal Service Oriented Architecture Enablement” and filed on Mar. 13, 2008, which is fully incorporated herein by reference.

### BACKGROUND AND SUMMARY

The invention relates generally to communication with external data sources. More particularly, the invention relates to techniques for providing access to a variety of data sources by utilizing a single tool that deploys a release of services and/or objects to an application computing device based upon services and/or objects selected by a user.

Generally, the present invention provides a service oriented architecture (SOA) system and method. A system in accordance with an embodiment of the present disclosure comprises a first computing device storing an external data source in memory. Further, the system has logic that retrieves data indicative of services and/or objects related to the external data source and generates data identifying the location of the services and/or objects and how the services and/or objects behave. The logic further generates logic for connecting to the services and/or objects.

A method in accordance with an embodiment of the present disclosure comprises defining services and objects for inclusion in a release parcel based upon selection input from a user, the services and objects identified from a plurality of external data sources. The method further comprises generating a release parcel, based upon the defining step, comprising data for identifying and describing the selected services and/or objects and comprising logic for communicating with the selected services and/or objects on the external data sources and deploying the release parcel to one or more application computing devices.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the figures.

FIG. 1 is a block diagram illustrating an exemplary service oriented architecture (SOA) system in accordance with an embodiment of the present disclosure.

FIG. 2 is a block diagram illustrating an exemplary service oriented architecture computing device as depicted in FIG. 1.

FIG. 3 is a block diagram illustrating an exemplary computing device as depicted in FIG. 1.

FIG. 4 is a graphical user interface (GUI) of the SOA system in FIG. 1 for selecting a release parcel in accordance with an embodiment of the present disclosure.

FIG. 5 is a GUI of the SOA system of FIG. 1 for selecting an external data source type in accordance with an embodiment of the present disclosure.

FIG. 6 is a GUI of the SOA system of FIG. 1 for selecting an external data source in accordance with an embodiment of the present disclosure.

FIG. 7 is a GUI of the SOA system of FIG. 1 for selecting services and/or objects from an external data source in accordance with an embodiment of the present disclosure.

FIG. 8 is a GUI of the SOA system of FIG. 1 for selecting application computing devices to which to deploy a release parcel in accordance with an embodiment of the present disclosure.

FIG. 9 is a flowchart depicting exemplary architecture and functionality of the system depicted in FIG. 1.

FIG. 10 is a flowchart depicting exemplary architecture and functionality of SOA logic as depicted in FIG. 2.

### DETAILED DESCRIPTION OF THE INVENTION

The present disclosure relates to a service-oriented architecture (SOA) system that allows developers of application software to access an external data source as if the external data source were part of a resident data source. According to one embodiment of the present disclosure, the number of distinct external data sources to which access may be provided is unlimited and access may be shared and/or reused across all connected databases.

As used in this present disclosure, “external data source” may refer to a database, a Web service, a Web site, and the like. However, other types of external data sources may be used in other embodiments of the present disclosure.

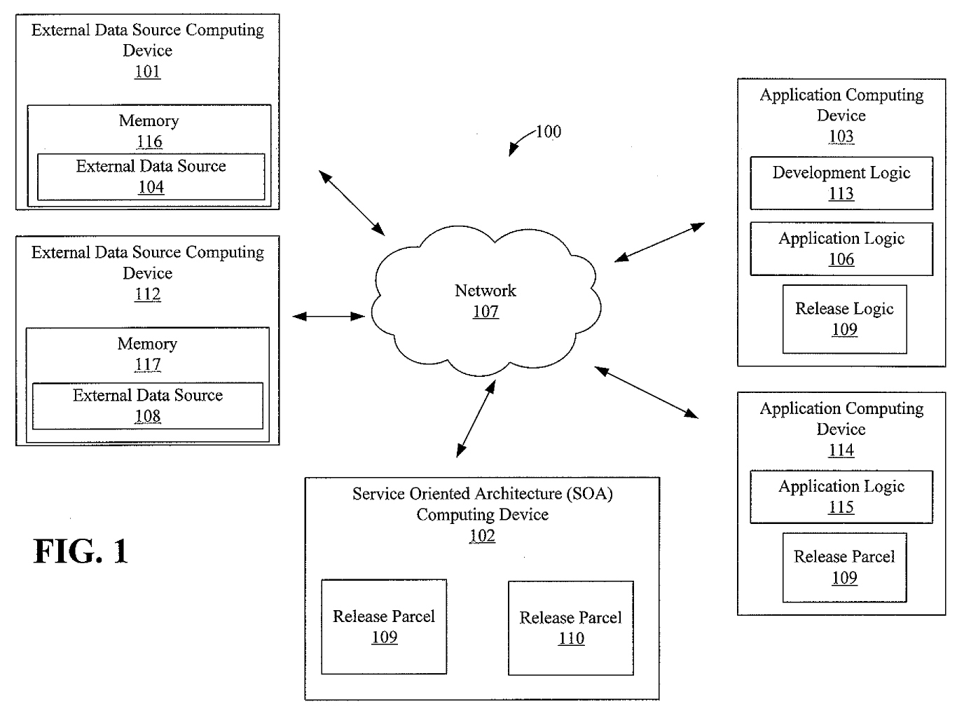

FIG. 1 depicts an exemplary SOA system 100 in accordance with an embodiment of the present disclosure. The SOA system 100 comprises one or more external data source computing devices 101, 112 and an SOA computing device 102. In addition, the system 100 comprises one or more application computing devices 103, 114. The external data source computing devices 101, 112, the SOA computing device 102, and the application computing devices 103, 114 communicate over a network 107.

Note that two external data source computing devices 101, 112 are shown. However, the SOA system 100 can accommodate additional or fewer external data source computing devices in other embodiments. Two external data source computing devices 101, 112 are shown for exemplary purposes.

Further note that two application computing devices 103, 114 are shown. However, the SOA system 100 can accommodate additional or fewer application computing devices in other embodiments. Two application computing devices 103, 114 are shown for exemplary purposes

Each external data source computing devices 101, 112 comprise external data sources 104, 108, respectively. The external data sources 104, 108 are stored in memory 116 and 117, respectively, resident to the external data source computing devices 101, 112. The external data source computing devices 101, 112 can be, for example, a database, Web services system, or a separate software application.

Note that the term “Web services system” refers to logic that defines one or more services in a Web Services Definition Language (WSDL) file, and the services are defined by an identifier and respective description of the service, e.g., its inputs and outputs. The term “services” can refer to services and/or objects contained in the external data source 104, 108 to which a user may desire to employ on the application computing devices 103, 114. For example, services can include the database tables, functions, procedures, packages, or views.

The Web service services system can use different message standards that follow a variety of information exchange protocols. For example, the Web service may use Extensible Markup Language (XML) that follows the Simple Object Access Protocol (SOAP) standard, i.e., a standard for communicating with Web services identified in the UDDI and described in the WSDL.

In the Web services system the WSDL file describes what particular Web services do. In addition, the Web services system may use different communication protocols in performing its message negotiation and transmission, e.g., Remote Procedure Call (RPC) or Hypertext Transfer Protocol (HTTP).

When the external data source 104, 108 is a database, the external data sources 104, 108 comprise data components and/or programmatic components. Data components may include database tables and views. Programmatic components may include database packages, procedures and functions. The external data source 104, 108 may be a database that houses data indicative of employees within an organization, for example. Such an exemplary external data source 104, 108 may include objects such as tables or views storing employee's names, telephone numbers, and birthdates. These described tables or views are data components.

In addition, the external data source 104, 108 may include objects such as procedures or functions for modifying data in the tables or views. For example, there may be a function for retrieving a single record corresponding to an identified employee from a table. In such an example, the function for retrieving the record is a programmatic component, and the function has as an input defined by data indicative of a name of an employee. In addition, the function has an output defined by the identified employee's record, e.g., the employee's telephone number and birth date. This function is a programmatic component. Note that a “function” may be different from a “procedure,” described herein, in that the function may have inputs and/or outputs. Whereas, a procedure may not have inputs or outputs.

When the external data source 104, 108 is a database, it may be an Oracle® application database and implemented with a database management system (DBMS). Note that the DBMS is logic that allows a user or an application program to view, extract, modify, and add data to the application database. For example, the DBMS may enable a function that when called allows a user (not shown) to add a new employee to a particular table in the external data source 104.

When the external data source 104, 108 is a Web service the external data source 104, 108 may be accessible via a number of different types of devices. Such devices include but are not limited to Java Database Connectivity (JDBC) drivers. The Web services may be accessed using other distinct external data source protocols known in the art or future-developed.

When the external data source 104, 108 is a software program, it may use a defined application program interface (API) (not shown). An API is a set of logic, including, for example, functions, procedures, and protocols that the software program uses in order to operate on a particular operating system, library, or service.

Regardless of the type of external data source 104, 108, the SOA computing device 102 retrieves descriptive information over the network 107 indicative of the many different services and/or objects that are included in the external data sources 104, 108. In one embodiment, the SOA computing device 102 retrieves the data indicative of the services and/or objects, based upon a user input, which is described further herein. The data identifying and describing the objects includes, for example, the name of the object, the number and type of inputs for the object, the number and type of outputs for the object, and/or a Unique Resource Locator (URL) or a Uniform Resource Identifier (URI). The SOA computing device 101 creates the release parcel 109, 110 based upon the data identifying and describing the objects.

The manner in which the SOA computing device 102 retrieves the data indicative of the services and/or objects is based upon the type of external data source 104, 108. For example, if the external data source 104, 108 is a Web services system, the SOA computing device 102 may retrieve service and/or object identifiers and corresponding descriptions from a Uniform Description Discovery and Integration (UDDI). A UDDI is an XML-based registry that includes information about where particular Web services are located on the internet.

Once the data indicative of the services and/or objects and their corresponding descriptions are retrieved from the external data sources 104, 108, the SOA computing device 102 generates a release parcel 109. Two release parcels 109, 110 are shown depicted in FIG. 1. Two release parcels 109, 110 are shown for exemplary purposes only, and the system 100 may includes additional or fewer release parcels 109, 110 in other embodiments. Notably, however, each release parcel 109, 110 is generated independent of any other release parcel, and the services and/or objects and corresponding descriptions are included in each release parcel 109, 110 separately, based upon a user input.

To generate the release parcels 109, 110, the SOA computing device 102 communicates over the network 107 with the external data sources 104, 108. As described herein, the nature of the communication is dependent upon the type of external data source 104, 108 with which the SOA computing device is communicating. The SOA computing device 102 retrieves data identifying each service and/or object selected by the user. The user may select, for example, an object from the external data source 104 and a service from the external data source 108 for incorporation into the release parcel 109. Note that release parcels 109, 110 may include additional or fewer objects than the example provided herein.

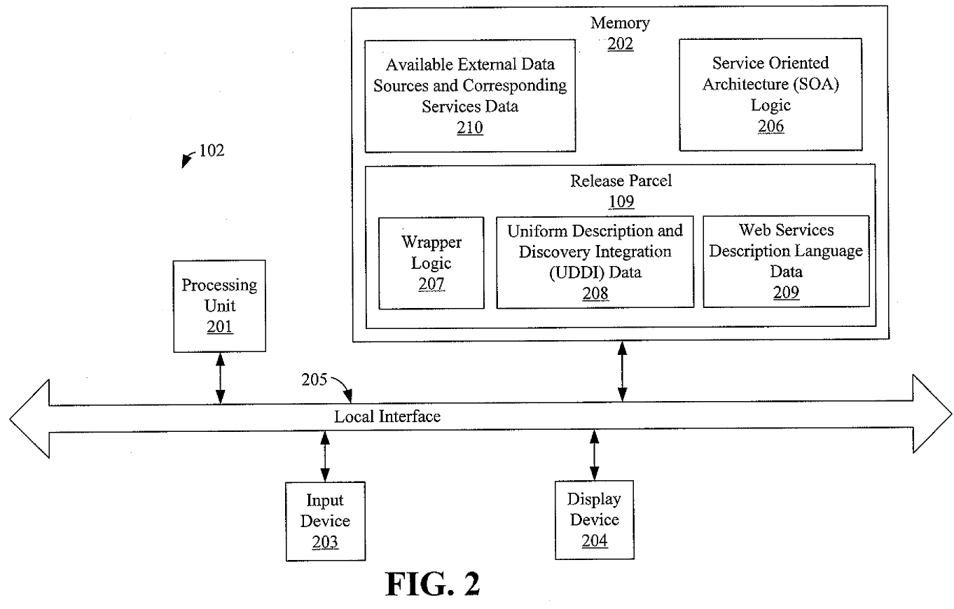

In one embodiment, each release parcel 109, 110 is a Web services system. In such an embodiment, the SOA computing device 102 generates those components (not shown) that define a Web services system, including, for example, a UDDI, a WSDL file and logic (not shown) for communicating, e.g., transmitting messages to/from, the external data sources 104, 108, which is described further with reference to FIG. 2.

When a particular release parcel 109, 110 is completed, the SOA computing device deploys a selected one of the release parcels 109 or 110 to the application computing devices 103, 114. Note that FIG. 1 depicts release parcel 109 deployed to the two separate application computing devices 103, 114. However, in another embodiment, release parcel 109 may be deployed to application computing device 103, and release parcel 110 may be deployed to application computing device 114. In another embodiment, release parcel 110 may be deployed to both application computing devices 103, 114. Note that the release parcels 109, 110 can be deployed simultaneously or at different times. Further note that different versions of release parcels 109, 110 may be generated and these distinct versions may also be deployed simultaneously, at different times, and/or to different application computing devices 103, 114.

The release parcel 109, 110 that is deployed to a particular application computing device 103, 114 is based upon the user's input. In this regard, the user may desire that the services and/or objects included in the release parcel 109 be available to application logic 106, whereas the user may desire that the services and/or objects included in the release parcel 110 be available to application logic 115.

The application logic 106 is logic that may perform operations related to the external data sources 104, 108. As an example, the application logic 106 may comprise a graphical user interface (GUI) (not shown) that allows a user (not shown) to perform human resource functions, e.g., retrieve employee data or add a new employee to the external data source 104 over the network 107.

In the SOA system 100, the SOA system 100 can expose objects within release parcels 109 and/or 110 to the application computing device 103 through deployment. The term “expose” means to make the object available for use by the application logic 106 on the application computing device.

Thus, in order for the application logic 106 to perform human resource fractions, for example, the application logic 106 accesses the external data sources 104, 108 indirectly through objects exposed by the release parcels 109, 110. In this regard, the application logic 106 does not communicate directly with the external data sources 104, 108. Instead, the application logic 106 accesses objects with the external data sources 104, 108 through the SOA computing device 102.

The SOA system 102 exposes objects by making the release parcels 109, 110 available at a particular address. For example, each release parcel 109, 110 may have associated with it a uniform resource locator (URL). The developer uses the URL to access one or more objects that were programmed in the release parcels 109, 110. In such an embodiment, the objects referentially included in the release parcels 109, 110 are exposed to the application logic 106 on the application computing device 103.

In one embodiment, the developer may use development logic 113 to generate the application logic 106. In such an embodiment, the developer inputs into the development logic 113 a URL identifying the release parcels 109, 110 to which the developer has access. Access through the URL gives the development logic 113 access to the objects referentially included in the release parcels 109, 110. The development logic 113 retrieves data indicative of the plurality of objects contained in the release parcel 109, 110 to which the developer has access and displays them to the developer. The developer can then select from the list of objects those objects that the developer needs to implement the application logic 106.

When using the SOA system 100, the developer need not be versed in the various DBMSs, APIs, or drivers associated with external data sources 104, 108. Further, the application logic 106 need not be programmed using the various languages necessary to access the external data sources 104, 108. For example, in order to access services through a Java® Database Connectivity (JDBC) driver, the application logic 106 need not be written in Java®. Instead, the SOA computing device 102 provides a universal gateway through which any type of application logic 106 can communicate with the external data sources 104, 108.

As indicated herein, in one embodiment, the SOA system 100 automatically discovers available external data sources 104, 108 on the network 107, for example through a UDDI. Upon discovery of the external data source 104, 108 the SOA system 100 can make the discovered external data source 104, 108, and its corresponding services and/or objects, available for selection by a user (not shown) of the SOA device 102 to program into the release parcels 109, 110 through a GUI, which is described further herein.

In another embodiment, the SOA system 100 receives identifying data directly from the user for locating the external data source 104 and the external data source computing device 101. Such identifying data may include, for example, an internet protocol (ip) address and a database name.

FIG. 2 depicts an exemplary SOA computing device 102 in accordance with an embodiment of the present disclosure. The exemplary SOA computing device 102 generally comprises a processing unit 201, a display device 204, an input device 203, and memory 202.

The SOA computing device 102 further comprises SOA logic 206. The SOA logic 206 can be software, hardware, or a combination thereof. In the exemplary SOA computing device 102, the SOA logic 206 is shown as software stored in memory 202. In addition, memory 202 stores data indicative of the release parcel 109. Note that FIG. 1 depicts two release parcels 109, 110. Only release parcel 109 is described further with reference to FIG. 2 for brevity. However, release parcel 110 is substantially similar to release parcel 109.

The release parcel 109 comprises those components needed to generate a Web services system. Such components include, but are not limited to wrapper logic 207, described further herein, UDDI data 208, and WSDL data 209. WSDL is used for exemplary purposes only, and other protocols may be used in other embodiments of the present disclosure.

The processing unit 201 may be a digital processor or other type of circuitry configured to run the SOA logic 206 by processing and executing the instructions of the SOA logic 206. The processing unit 201 communicates to and drives the other elements within the SOA computing device 102 via a local interface 205, which can include one or more buses.

The input device 203 is a device that can be used to enter data into the SOA computing device 102. As examples, the input device 203 may be a keyboard, a switch, a mouse, and/or other type of interface that can be used to receive input data (not shown) from a user (not shown) of the SOA computing device 102.

The display device 204 is any device that can display data to the user. For example, the display device 204 may be a computer monitor.

When stored in memory 202, the SOA logic 206 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

During operation, the SOA logic 206 discovers or receives data identifying external data sources 104, 108 available on the network 107 (FIG. 1). Once an external data source 104, 108 is discovered or identified, the SOA logic 206 retrieves a list of all available services and/or objects within the external data source 104, 108. The SOA logic 206 stores data 210 indicative of available external data sources and corresponding available services.

In one embodiment, the SOA logic 206 may retrieve data identifying available services and their locations on the network 107 from a UDDI. In such an embodiment, the SOA logic 206 would query the UDDI registry and retrieve data related to the services, i.e., the interface description and URL. Note that the UDDI is an open standard for publishing services, which includes the data related to the services, as described herein.

In another embodiment, if the external data source 104, 108 is a SQL database driven by a JDBC, then the SOA logic 206 executes a function that retrieves a list of all the tables, for example, in the external data source 104, 108.

In another embodiment, the SOA logic 206 could use domain name service service discovery (DNS-SD). In such an embodiment, the SOA logic 206 employs the DNS-SD to troll the network 107 for available services.

Once a list is of available services and/or objects on the network 107 are discovered or identified, the SOA logic 206 displays data indicative of each of the available objects on the network 107 to the display device 204 via a graphical user interface. The user selects, via the input device 203, which services or objects that the user desires to be included in the release parcel 109. Notably, the user may select objects from the external data source 104 and/or the external data source 108 to include in the release parcel 109.

Once the user has selected one or more services and/or objects that he desires to be included in the release parcel 109, the SOA logic 206 retrieves additional data including an interface description and a URL for each of the services and/or objects selected. The interface description describes how the object is to be accessed. For example, if the object is a function, the interface description would describe the inputs and outputs of the function. The URL is an identifier that identifies where the object is located so that the object can be accessed.

Once the SOA logic 206 receives the additional data, including the interface description and the URL, the SOA logic translates the additional data into UDDI data 208, which describes where a selected service is found on the network 107. In addition, the SOA logic 206 translates the additional data into WSDL language 209, which describes what each selected service does. Furthermore, the SOA logic 206 generates wrapper logic that communicates with the external data sources 104, 108 through whatever protocols are used by the external data source 104, 108.

As described above, in order for application logic 206 to use objects on the SOA computing device 101, the release parcel 109 is “exposed” to the application computing devices 103, 114. In one embodiment, the release parcels 109, 110 are associated with a particular address (e.g., a URL) on the network 107. This URL can be used to locate the release parcel 109.

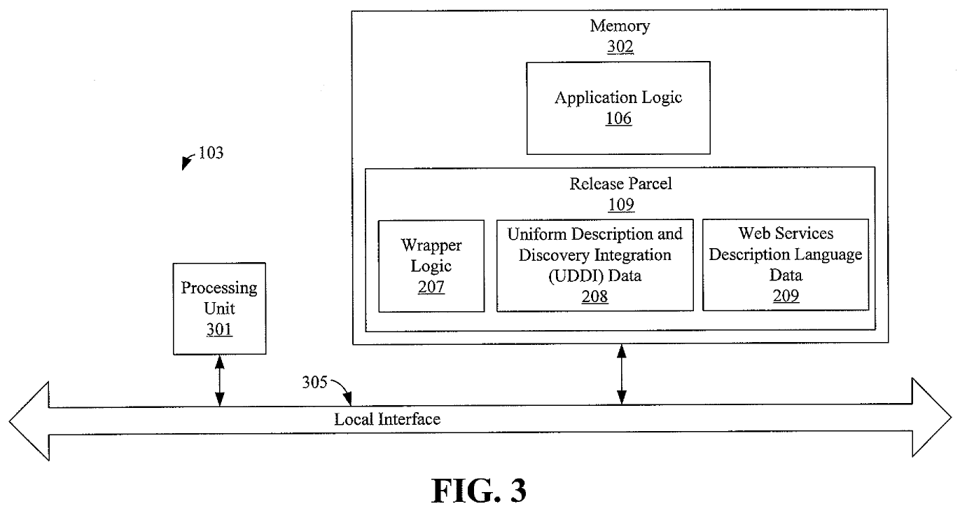

To expose the release parcel 109 to the application computing devices 103, 114, the release parcel 109 is deployed to the application computing devices 103, 114. In this regard, the release parcel 109 is transmitted to the application computing devices 103, 114 and stored for access by the application logic 106, described further with reference to FIG. 3.

In addition, the URL for the release parcel 109 may be provided to a developer (not shown), who enters the URL into the development logic 113. The development logic 113 communicates with the release parcel 109, in particular the UDDI, to retrieve services and/or objects available in the release parcel 109, 110 for use in the application logic 106. The developer can select one or more of the object or services for inclusion in the application logic 206.

FIG. 3 depicts an exemplary application computing device 103 in accordance with an embodiment of the present disclosure. The exemplary application computing device 103 generally comprises a processing unit 301 and memory 302. Note that FIG. 3 depicts the application computing device 103; however, application computing device 114 is substantially similar to application computing device 103. Only application computing device 103 is described in more detail for brevity.

In the exemplary application computing device 103, the application logic 106 is shown as software stored in memory 302. In addition, memory 302 stores data indicative of the deployed release parcel 109.

The processing unit 301 behaves substantially identical to the processing unit 301 described with reference to FIG. 2. In this regard, the processing unit 301 communicates to and drives the other elements within the application computing device 103 via a local interface 305, which can include one or more buses.

During operation, the application computing device executes the application logic 106. During execution, the application logic 106 calls a particular Web service. Upon calling the Web Service, the wrapper logic 207 creates a communication channel through which messages can be sent to the particular service located on the external data source 104, 108. Further, the wrapper logic 207 transmits data indicative of a message from the application logic 106 and receives data indicative of a message from the external data sources 104, 108 in response to the messages transmitted.

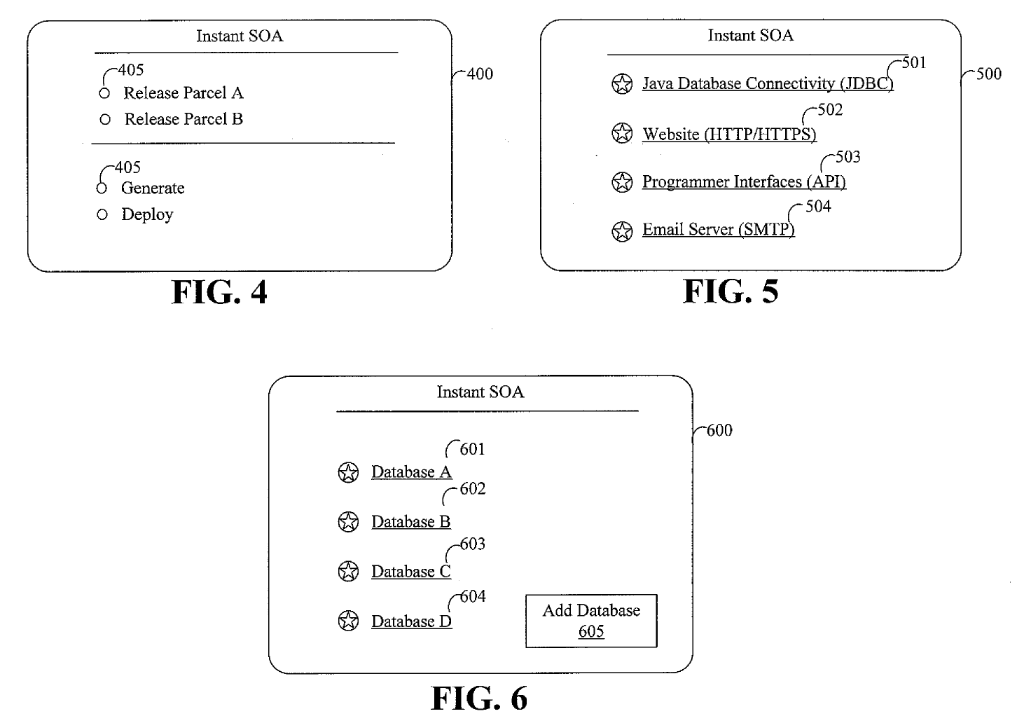

The FIGS. 4-8 depict exemplary graphical user interfaces (GUIs) 400-800 displayed by the SOA logic 206 (FIG. 2) during an exemplary implementation of the SOA system 102 (FIG. 1). Note that the following text describing FIGS. 4-8 describes one exemplary implementation of the SOA system 102, and other implementations are possible in other embodiments.

FIG. 4 depicts an exemplary GUI 400 of the SOA system 102 (FIG. 1). The SOA logic 206 (FIG. 2) displays GUI 400 which describes initial selections of “Release parcel A,” and “Release parcel B,” selectable through selection boxes 405 via the input device 203 (FIG. 2).

Note that two release parcels are shown for exemplary purposes only. Other additional or fewer release parcels may be displayed in other embodiments. Note that a user (not shown) may, through the SOA logic 206, add a new release parcel or edit an existing package.

To generate or deploy Release parcel A or Release parcel B, the user selects one selection box 405 corresponding to the release parcel the user desires to generate or deploy. Further, the GUI 400 comprises a “Generate” selection and a “Deploy” selection, and the user selects whether the user desires to generate the identified release parcel or deploy the identified release parcel by selecting selection box 401 corresponding to the action the user desires to take.

Once the user selects to generate a particular release parcel, the SOA logic 206 displays a GUI 500 depicted in FIG. 5. The SOA logic 206 displays the GUI 500 to a display device 204 (FIG. 2), and a user (not shown) using the input device 203 (FIG. 2) selects one of a plurality of hyperlinks 501-504 indicative of a type of external data source 104 (FIG. 1) from which the user desires to incorporate services and/or objects into the selected release parcel.

Exemplary external links for exemplary types of external data sources 104 include a “Java database connectivity (JDBC)” link 501, a “Website (HTTP/HTTPS) link 502, a “Programmer Interface (API)” link 503, and an “Email Server (SMTP) link 504. Note that other types of external data sources 104 are possible in other embodiments of the present disclosure.

Note that one external data source 104, for example the data source indicated by the JDBC link 501, can encompass different types of JDBC drivers because there are many different drivers known in the art for connecting to a Java database. Exemplary types of JDBC drivers can include drivers for Excel spreadsheet, Oracle®, MySQL®, FilmMaker, and others known in the art or future-developed.

In an example, the user selects the JDBC link 501, and the SOA logic 206 (FIG. 2) displays a GUI 600 as shown in FIG. 6 to the display device 204. In response to the user selecting the JDBC link 501, the SOA logic 206 displays a list of hyperlinks 601-604 indicative of one or more existing databases to which the user's SOA computing device 102 and the SOA logic 206 can connect, including hyperlink 501 for selecting Database A, hyperlink 502 for selecting Database B, hyperlink 503 for selecting Database C, and hyperlink 504 for selecting Database D corresponding to the selected type of external data source 104, 108 (FIG. 1).

Note that the particular databases displayed correspond to the type of external data source 104, 108 (FIG. 1) indicated in GUI 500 (FIG. 5) by the user. In the example, the user selected the JDBC line 501, therefore, the links 601-604 correspond to those external data sources 104, 108 that can be accessed via a JDBC driver on the network 107 (FIG. 1).

In one embodiment of the present disclosure, the SOA logic 206 can add an additional database to the data 210 (FIG. 2) indicative of the available external data sources and corresponding services, indicated by the hyperlinks 601-604. In such an embodiment, the SOA logic 206 would request, and the user would enter data uniquely identifying the database that is being added to those already available. For example, if the database being added is an Oracle database, the SOA logic 206 would request, and the user would enter data indicative of a host name, a database name, and a transparent network substrate (TNS) port. Note that the TNS port is a communication channel through which the wrapper logic 207 (FIG. 2) can communicate with the added external data source 104, 108. The user can then select the “Add Database” icon 605, and the SOA logic 206 adds the identifying information to the data 210 indicative of the available external data sources and corresponding services.

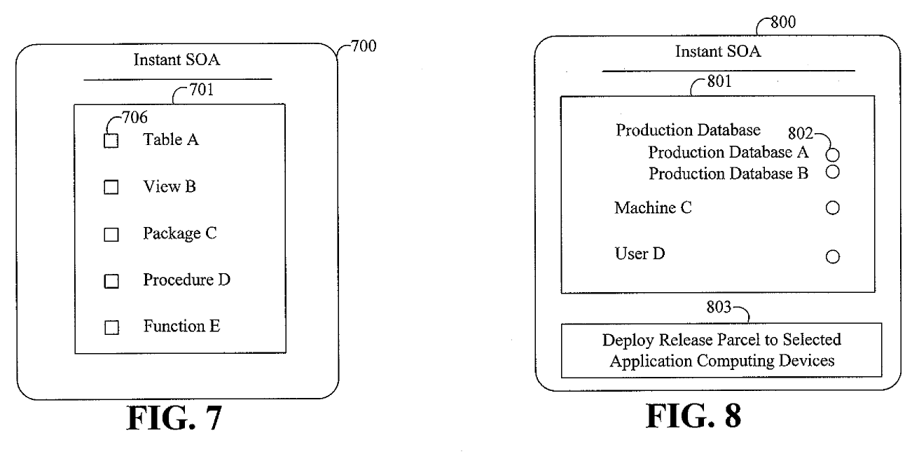

In response to the user selecting one of the database hyperlinks 601-604, the SOA logic 206 (FIG. 2) displays a GUI 700 depicted in FIG. 7 comprising a list of identifiers of available services and/or objects for the selected database from GUI 600 (FIG. 6). Such identifiers may reference, for example, data and/or programmatic components, available for the selected database. Each of the identifiers corresponds to a user input selector, for example a check box 706, so that the user can select one or more of the services and/or objects to be included in the release parcel selected in GUI 400 (FIG. 4).

Note that types of services and/or objects can include, but are not limited to, tables, views, packages, procedures, and functions. These are exemplary services and/or objects for which the SOA logic 206 generates a release parcel 109, 110 (FIG. 1).

In the exemplary GUI 700, there are exemplary services and/or objects listed, which include “Table A,” “View B,” “Package C,” “Procedure D,” “Procedure E,” and “Function F.” Once the user selects one or more of the boxes 706, the SOA logic 206 creates a Web services system, as described hereinabove, related to the selected services and/or objects. In this regard, the SOA logic 206 creates UDDI data 208 that identifies each of the selected services and where each service is located on the network 107 (FIG. 1). In addition, the SOA logic 206 creates WSDL data 209 that describes what the services identified in the UDDI data do. Further, the SOA logic 206 creates the wrapper logic 207 for communicating with the one or more external data sources 104, 108. Once the services and/or objects are selected, the SOA logic 206 displays to the user a GUI 800 as shown in FIG. 8. GUI 800 comprises a list 801 of application computing devices 103, 114 (FIG. 1) to which the user can deploy the release parcel generated. As examples, the list 801 may identify application devices 103, 114 including “Production Database A,” “Production Database B,” “Machine C,” and “User D.”

The user selects one of the listed application computing devices from the list via a user input selector, for example the check circle 802. After selection of the application devices 103 from the list 801 to which the user desires to deploy the selected services and/or objects, the user then selects the “Deploy to Selected Application Computing Devices” pushbutton 803.

Upon selection of the pushbutton 703, the SOA logic 206 makes each of the services and/or objects selected available to each of the application computing devices 103, 114 (FIG. 1) selected.

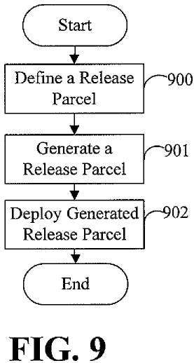

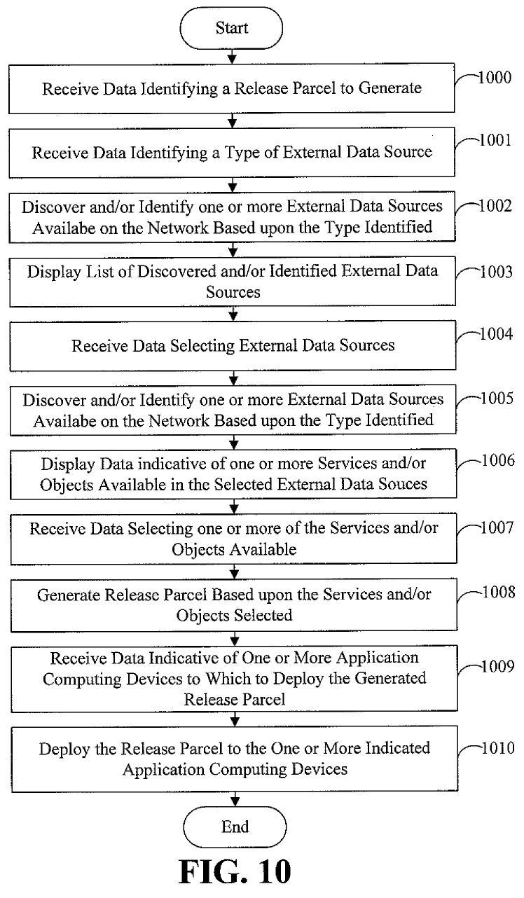

FIG. 9 is a flowchart depicting exemplary architecture and functionality of the system 102 in accordance with an embodiment of the present disclosure. The system 102 defines a release parcel 109, 110 (FIG. 1), as indicated in step 900. Such definition is accomplished by the system 102 by receiving external data source selections and services and/or object selections, through GUIs 600 and 700, from a user (not shown), which is described further with reference to FIG. 10. The external data source selections and services and/or object selections define what is to be included in the release parcel 109, 110.

Note that a single release parcel 109, 110 may include a number of different services and/or objects. In addition, the number of different services and/or objects can be available from a number of different external data sources 104, 108 and included in the same release parcel 109, 110.

The system 102 generates the release parcel 109, 110, as indicated in step 901. The system 102 generates the release parcel 109, 110 based upon the external data source selection and services and/or object definition accomplished in step 900.

Once the release parcel 109, 110 is generated, the SOA system 102 deploys the generated release parcel 109, 110 to one or more application computing devices 103, 114 (FIG. 1). The user may select, for example through GUI 800 (FIG. 8) which application computing devices 103, 114 available on the network 107 (FIG. 1) to which the user desires to deploy the generated release parcel 109, 110.

Note that FIG. 10 is a flowchart depicting exemplary architecture and functionality of the SOA logic 206 (FIG. 2).

The SOA logic 206 receives data identifying a release parcel 109, 110 (FIG. 1) to generate, as indicated in step 1000. The data may identify an existing release parcel 109, 110 to which a user (not shown) desires to add additional services and/or objects or the data may identify a new release parcel 109, 110 that the user would like to create. In one embodiment, the SOA logic 206 receives data identifying a release parcel 109, 110 through the GUI 400 (FIG. 4).

The SOA logic 206 then receives data identifying a type of external data source 104, 108 (FIG. 1) to which the user desires to connect to through application logic 106, 116 (FIG. 1), as indicated in step 1001. The external data source type may be, for example, JDBC, HTTP/HTTPS, API, or a simple mail transfer protocol (SMTP) as used in email servers. In one embodiment, the SOA logic 206 receives data identifying an external data source type through the GUI 500 (FIG. 5).

The SOA logic 206 discovers and/or identifies one or more external data sources 104, 108 (FIG. 1) available on a network 107 (FIG. 1), as indicated in step 1002. The SOA logic 206 displays a list of the discovered or identified external data sources 109, 110, as indicated in step 1003. In one embodiment, the SOA logic 206 displays a list of databases corresponding to a JDBC type database that the SOA logic 206 has discovered and/or identified in step 1002 as shown in GUI 600 (FIG. 6).

The SOA logic 206 receives data identifying the external data source that the user desires to obtain services and or objects from to include in the release parcel 109, 110, as indicated in step 1004. The data identifying the external data source through GUI 600.

Upon selection by the user of a particular external data source 104, 108 in step 1004, the SOA logic 206 discovers and/or identifies one or more services and/or objects available in the selected external data sources 104, 108, as indicated in step 1005. The SOA logic 206 may discover the services and/or objects available on a selected external data source 104, 108 in a number of ways. For example, if the external data source 104, 108 is a database managed by a JDBC driver, the SOA logic 206 can call a JDBC function that lists, for example, all the tables and/or procedures available for the external data source 104, 108. If the external data source 104, 108 is a Web services system, the SOA logic 206 can query a UDDI or other registry that lists services available from the external data source 104, 108.

The SOA logic 206 displays the discovered services and or objects to the user, as indicated in step 1006. In one embodiment, the SOA logic 206 displays the list of available services and/or objects through GUI 700 (FIG. 7). The SOA logic 206 receives data selecting one or more of the services and/or objects from one or more external data sources 104, 108 to be included in the release parcel 109, 110 from the user, as indicated in step 1007.

Upon identification by the user of the services and/or objects the user desires to be included in the release parcel 109, 110, the SOA logic generates the release parcel 109, 110 based upon the user's selection, as indicated in step 1008. In one embodiment, the release parcel 109, 110 is a Web services system that includes UDDI data 208 (FIG. 2), WSDL data 209 (FIG. 2), and wrapper logic 207 (FIG. 2).

The SOA logic 206 then receives data indicative of one or more application computing devices 103, 114 (FIG. 1) to which the user desires to deploy the generated release parcel 109, 110, as indicated in step 1009. The SOA logic 206 deploys the release parcel to the identified application computing devices, as indicated in step 1010.

Now, therefore, the following is claimed:

1. A system comprising:
a first computing device storing an external data source in memory; and
first logic configured to retrieve data indicative of services and/or objects related to the external data source and generate data identifying the location of the services and/or objects and how the services and/or objects behave, the logic further configured to generate second logic for connecting to the services and/or objects.

2. The system of claim 1, wherein the first logic is configured deploy the second logic and the data to one or more application computing devices.

3. The system of claim 2, wherein application logic stored in memory on the application computing device communicates with the external data source through the second logic.

4. The system of claim 1, wherein the first logic is configured to discover a plurality of external data sources on a network.

5. The system of claim 4, wherein the first logic is configured to display external data source data indentifying the plurality of external data sources available on a network to a user.

6. The system of claim 5, wherein the first logic is configured to receive a selection via an input device indicating at least one external data source from the external data source data.

7. The system of claim 6, wherein the first logic is configured to discover one or more services and/or objects from the at least one selected external data source.

8. The system of claim 7, wherein the first logic is configured to display service and/or object data identifying the one or more services and/or objects discovered.

9. The system of claim 7, wherein the first logic is configured to receive a selection via an input device indicating one or more services and/or objects for inclusion in the second logic and data identifying the location of the services and/or objects and how the services and/or objects behave.

10. The system of claim 1, wherein the data identifying the location of the services is stored as Uniform Description Discovery and Integration (UDDI) data.

11. The system of claim 1, wherein the data identifying how the services and/or objects behave is stored as Web Services Description Language (WSDL) data.

12. A method, comprising:
defining services and objects for inclusion in a release parcel based upon selection input from a user, the services and objects identified from a plurality of external data sources;
generating a release parcel, based upon the defining step, comprising data for identifying and describing the selected services and/or objects and comprising logic for communicating with the selected services and/or objects on the external data sources; and
deploying the release parcel to one or more application computing devices.

13. The method of claim 12, wherein the defining step further comprises discovering one or more available external data sources on a network.

14. The method of claim 13, wherein the defining step further comprises:
displaying identifiers identifying the one or more available external data sources on the network; and
receiving external data source selection data from the user indicative of the external data source from which the user desires to obtain the services and/or objects.

15. The method of claim 14, wherein the defining step further comprises:
discovering one or more available services and/or objects of the selected external data sources.

16. The method of claim 15, wherein the defining step further comprises:
displaying identifiers identifying the one or more available services and/or objects; and
receiving services and/or object selection data from the user indicative of the services and/or objects the user desires to include in the release parcel.

17. The method of claim 12, wherein the generating step further comprises:
generating Uniform Description Discovery and Integration (UDDI) data for the selected services and/or objects.

18. The method of claim 17, wherein the generating step further comprises:
generating Web Services Description Language (WSDL) data for the selected services and/or objects.

19. The method of claim 12, wherein the deploying step further comprises:
Displaying a list of available application computing devices to the user; and
receiving application computing device selection data indicative of one or more of the displayed application computing devices to which the user desires to deploy the release parcel.

20. The method of claim 19, wherein the deploying step further comprises:
deploying the release parcel to each of the one or more selected application computing devices.
